(19) United States
(12) Patent Application Publication
(10) Pub. No.: US 2016/0034830 A1
(43) Pub. Date: Feb. 4, 2016

(54) METHODS AND SYSTEMS FOR SAFETY, SECURITY, AND ENVIRONMENTAL MANAGEMENT

(71) Applicant: AcuTech Software, LLC, Vienna, VA (US)

(72) Inventor: David A. MOORE, Vienna, VA (US)

(21) Appl. No.: 14/814,200

(22) Filed: Jul. 30, 2015

Related U.S. Application Data
(60) Provisional application No. 62/030,769, filed on Jul. 30, 2014.

(51) Int. Cl. G06Q 10/06

(52) U.S. Cl. CPC G06Q 10/0635

(57) ABSTRACT

A method, system and computer program for managing assessment, comprising creating a project for an assessment associated with a company and a particular site for a selected issue or issues, selecting a protocol for the project, wherein the protocol includes one or more elements with associated questions, receiving assessment information in response to the questions, and generating, via the processing device, a report based on the assessment information.

### RELATED APPLICATIONS

This application claims priority to U.S. Provisional Patent Application No. 62/030,769 entitled “Methods and Systems for Safety, Security, and Environmental Management,” filed Jul. 30, 2014, which is incorporated herein by reference in its entirety.

### BACKGROUND

In industries where companies use, for example, hazardous materials, the companies have to comply with numerous safety, security, environmental, and other internal and external requirements to ensure that the companies are meeting those requirements and especially that hazardous materials are properly handled by the company. The requirements may be company created regulations, government regulations, and/or international standards. To ensure that a company is complying with their safety, security, or environmental governance requirements or regulations, assessments, and reviews may be performed to assess the company. A company may generally have multiple sites that may need to be assessed. As such, the assessment may be occurring in various locations and by multiple individuals. It may be difficult for a company to manage the assessment occurring in the various locations and/or distill the information received from the assessment. Moreover, the assessment at the various locations may not be consistent, and thus, the results of the assessment may vary depending on the information collected during the assessment.

Thus, there is a need in the art for managing the governance function including the assessment of companies using dangerous and/or hazardous materials.

### SUMMARY

Aspects of the present invention relate to methods and systems that, among other things, aid a user in creating an assessment of a company and performing the assessment. Aspects of the present invention also relate to methods and systems that create uniformity between assessments being performed in various locations by a plurality of individuals. In addition, aspects of the present invention relate to managing ongoing assessments and generating risk analysis of the companies being assessed.

Additional advantages and novel features relating to aspects of the present invention will be set forth in part in the description that follows, and in part will become more apparent to those skilled in the art upon examination of the following or upon learning by practice thereof.

### DESCRIPTION OF THE FIGURES

In the drawings:

FIG. 1 illustrates an example system for use in accordance with an aspect of the present invention;

FIG. 2 illustrates an example method for managing assessment in accordance with an aspect of the present invention;

FIG. 3 illustrates an example method for creating a protocol in accordance with an aspect of the present invention;

FIG. 4 illustrates various features of an example computer system for use in conjunction with aspects of the present invention;

FIG. 5 illustrates an example system diagram of various hardware components and other features for use in accordance with aspects of the present invention;

FIG. 6 is an example of a risk matrix in accordance with an aspect of the present invention;

FIG. 7 is an example of likelihood levels in accordance with an aspect of the present invention;

FIG. 8 is an example of consequence levels in accordance with an aspect of the present invention;

FIG. 9 is an example of a dashboard in accordance with an aspect of the present invention;

FIG. 10 is an example of weights for questions and answers according to an aspect of the present invention;

FIG. 11 is an example of an assessment scoring according to an aspect of the present invention; and

FIG. 12 is an example of discrepancies found during an assessment according to an aspect of the present invention.

### DETAILED DESCRIPTION

Aspects of the present invention relate to methods and systems that, among other things, aid a user in creating an assessment of a company and performing the assessment. For example, the assessment may be related to the safety, security, and/or environmental management of a company using dangerous and/or hazardous materials.

Aspects of the present invention also relate to methods and systems that consolidate assessment information from assessments being performed in various locations by a plurality of individuals into a single dashboard view so that users of the system may use the system to manage the assessment being performed and generate risk analysis of the companies being assessed. For example, if a company has locations worldwide, one or more assessment may be ongoing for the company across the world. The system may receive assessment information from the locations worldwide and synchronize the assessment information received in near real-time. The system may also track the progress of each assessment being performed. In addition, the system may be used to measure how well an organization may be complying with one or more company regulations, industry regulations, industry best practices, and/or government regulations. For example, the system may generate one or more reports based on the assessment information received that may be used in measuring the safety, security, and/or environmental programs of the company.

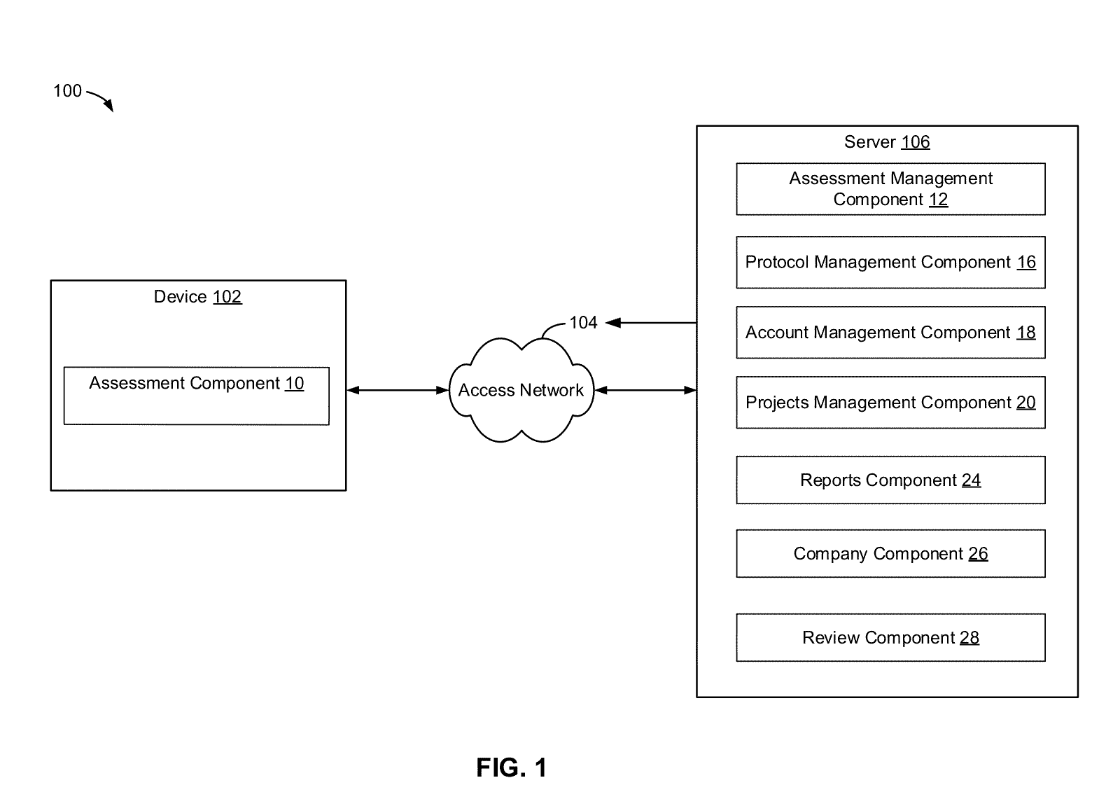

Referring now to FIG. 1, illustrated therein is an example connectivity system 100 in accordance with an aspect of the present invention. System 100 may include one or more devices 102 communicating through one or more access networks 104 with one or more servers and/or computing devices 106. Device 102 may include, for example, a cellular telephone, a navigation system, a computing device, a camera, a personal digital assistant (PDA), a music device, a gaming device or a handheld device having wired, optical, wireless or other connection capability, among other devices. Server/computing device 106 may include any mobile or fixed computing device coupled to a network. Sever/computing device 106 may include, but is not limited to, a computing device, a server, a cellular telephone, a camera, a PDA, a music device, a gaming device, a navigation system, or a handheld device having wired, wireless or other connection capability, among other devices. Furthermore, access network 104 may provide one or more types of communication connections or other couplings, such as any suitable type of wireless airlink, to device 102 and server 106.

Device 102 may include an assessment component 10 operable to assist a user of device 102 in creating an assessment for a company, performing an assessment, and/or managing an assessment. Assessments may be performed using the system for one or more companies and/or one or more subdivisions of a company (e.g., company sites, company operations, company departments, company activities).

In an aspect, a user may use assessment component 10 to perform an assessment of the safety, security, and/or environmental management of a company using potentially dangerous and/or hazardous materials. For example, the company may be in the petroleum or chemical industry, and a user may perform an assessment to assess the safety, security and/or environmental programs of the company. The company may also use hazardous materials, and a user of device 102 may use assessment component 10 to assess the safety, security and environment programs of the company when dealing with hazardous materials.

Assessment component 10 may aid a user and/or guide a user through a series of questions a user must ask and provide answers to during an assessment. For example, the system may present a series of questions a user must ask during the assessment and may receive user input with the answers to the questions. In addition, assessment component 10 may automatically or otherwise identify areas a user should inspect during an assessment and/or individuals a user should interview during the assessment. Assessment component 10 may also automatically or otherwise identify evidence (e.g., images, documents, maps, plans, sound recordings, readings, plots, reports) a user should collect during an assessment. In an aspect, a user may use assessment component 10 to link to and/or attach evidence collected during the assessment to one or more questions asked during the assessment and/or answers provided. In addition, assessment component 10 may also track the progress a user is making during an assessment and provide a user updates on schedules and any upcoming deadlines.

Assessment component 10 may allow a user to create, edit, and/or delete company information. For example, a user may use assessment component 10 to create a company profile (e.g., company name, subdivisions of a company, company contact information, and company locations), edit the company profile, and/or delete the company profile. Assessment component 10 may also allow a user to create, edit and/or delete user accounts associated with a company. For example, a user may use assessment component 10 to create user accounts, system access rights or privileges for the user accounts, and/or user profile information.

Assessment component 10 may also allow a user to create a project for an assessment, edit a project, and/or delete a project. For example, assessment component 10 may allow a user to input information to create one or more projects for assessing a company. In addition, assessment component 10 may allow a user to create, update, and/or delete a protocol to use during an assessment. A protocol may include a predefined set of elements that need to be covered during an assessment. Assessment component 10 may also allow a user to assign one or more protocols to a project, update protocols assigned to a project, and/or delete a protocol assigned to a project.

Assessment component 10 may allow a user to view one or more reports or status updates of an assessment. For example, assessment component 10 may provide the user with daily status reports of an ongoing assessment and/or a risk matrix report for the company based on the assessment information received.

Assessment component 10 may interface with assessment management component 12 on server 106. Assessment management component 12 may manage one or more assessments being performed by the system. In an aspect, assessment management component 12 may interface with a protocol management component 16 to manage one or more protocols that may be used for one or more assessment. The protocols may relate to company standards, industry standards, best practices for an industry, international standards, and/or government regulations for the industry (e.g., OSHA). For example, protocol management component 16 may receive and store one or more protocols. In addition, protocol management component 16 may receive a selection of one or more protocols to use during an assessment.

Assessment management component 10 may also interface with an account management component 18 to aid in creating and managing one or more user accounts for the system. In addition, assessment management component 10 may interface with a projects management component 20 to aid in creating and managing one or more projects on the system. For example, projects management component 20 may receive and store information for new projects and/or update existing projects.

Assessment management component 10 may interface with reports component 24. Reports component 24 may generate and store one or more reports relating to the assessment and/or projects executed by the system. Assessment management component 10 may also interface with a company component 26. Company component 26 may aid in creating and/or editing company information. In addition, assessment management component 10 may interface with review component 28.

As such, a user may use the system to create an assessment of the safety, security, and/or environmental programs of a company using, for example, potentially dangerous or hazardous materials, and use the system to perform the assessment. In addition, the user may use the system to generate one or more reports for the company based on the assessment information received.

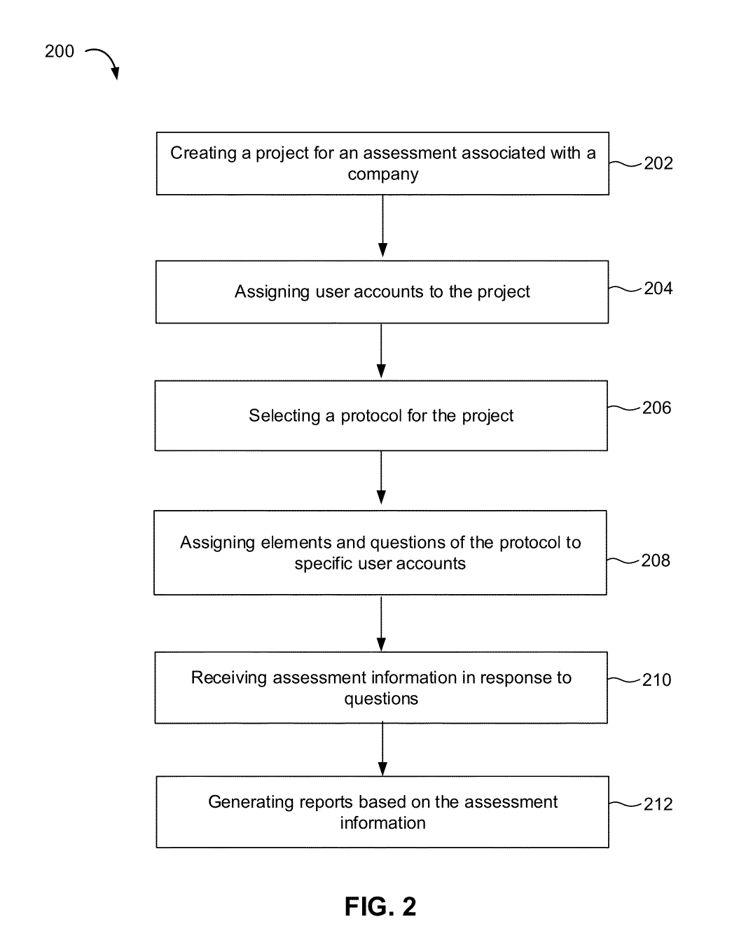

Referring now to FIG. 2, illustrated therein is an example method flow 200 for managing assessment in accordance with an aspect of the present invention.

The method may include creating a project for an assessment associated with a company 202. A project may, for example, be enterprise wide, specific for a country or region, specific for a location, or specific for a division of the company. For example, the system may be used to create a project associated with one or more companies and/or one or more subdivisions of a company. The system may receive input for creating a project, such as, but not limited to, selecting a project name, selecting a project location, selecting a project logo, selecting a type of assessment to perform and entering assessment information. Assessment information may include, for example, an assessment purpose, assessment scope, assessment objectives, a start date, an end date, and deadlines for the assessment.

The method may include assigning user accounts to the project 204. In an aspect, the system may assign one or more user accounts to the project. The user accounts may have different access rights to the project. For example, some user accounts may be able to have more access rights to the project (e.g., create projects, edit projects, delete projects, adding users to projects) while other user accounts may have limited access rights to the project (e.g., review assessment information received, receive reports, entering assessment information).

The method may also include selecting a protocol for the project 206. A protocol may include a series of elements to cover during an assessment. Each series of elements may be a category within the protocol and may include a set of questions related to the element. A project may have a single protocol or a plurality of protocols. The protocols may relate to company standards, industry standards, best practices for an industry, international standards, and/or government regulations for the industry (e.g., OSHA). The system may have pre-loaded protocols for a user to select for the project. For example, the system may have one or more pre-defined protocols, with elements and questions that relate to international standards, government regulations, and/or industry best practices. A pre-defined protocol may include, for example, a template with a predefined set of questions to ask during an assessment.

In addition, the system may allow a user to create a custom protocol for the company, the project, various sites of the company, and a country or region. A protocol may include questions with fixed answers (e.g., a user must select one or more from a predefined set of answers). In addition, the questions in a protocol may also include scaled answers (e.g., on a scale of 1 to 10) and/or answers entered by a user (e.g., via inputted text, speech, images). The questions in a protocol may also have a number of formulas associated with a ranking scheme. For example, each question and answer of the protocol may have an associated score and/or weight. The system may calculate an overall score for the project based on the associated scores and weights of the questions and answers received. The overall score for the project may be used by the system in assessing how well an organization may be complying with the safety regulations.

The method may include assigning elements and questions of the protocol to specific user accounts 208. For example, the system may receive inputs from a user selecting all, or a portion of, the questions in the protocol to assign to one or more user accounts for the project. Multiple user accounts may have the same elements of the protocol assigned to the user accounts and/or different elements of the protocols assigned to the user accounts. The user accounts may have the same elements assigned to the user accounts but different questions assigned.

The method may include receiving assessment information in response to questions 210. The system may receive assessment information from users of the system performing the assessment. Assessment information may include, but is not limited to, answers to questions asked during the assessment and evidence collected during an assessment (e.g., images, voice recordings, documents, maps, plots, reports). The system may allow a user to link any evidence collected during an assessment to the answers provided during the assessment.

The method may include generating reports based on the assessment information 212. For example, the system may generate one or more reports based on the assessment information received. Reports may include, but are not limited to, risk matrix reports, setup reports, assessment progress reports, debrief reports, recommendation reports, evidence reports, statistical reports, protocol reports, protocol template reports, question source reports, worksheet reports, and custom reports. Reports may be generated, for example, for various levels, such as corporate, regional, country, or site. In addition, reports may be generated for a single project or a plurality of projects.

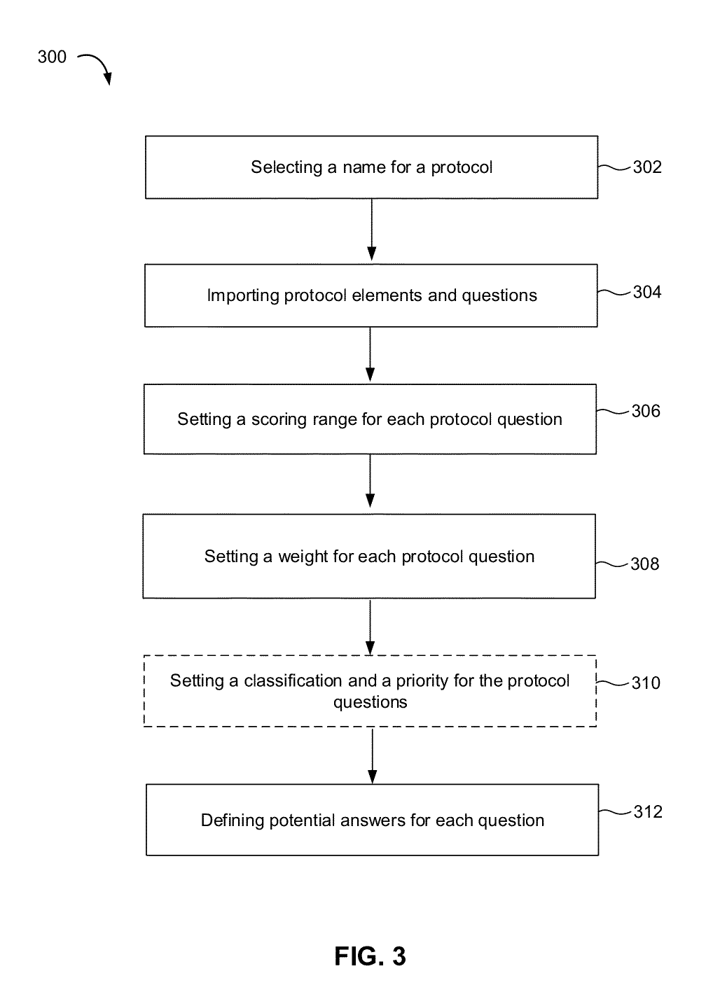

Referring now to FIG. 3, illustrated therein is an example method flow 300 for creating a protocol in accordance with an aspect of the present invention. The method may include selecting a name for a protocol 302. For example, the system may receive inputs from a user with a name for the protocol.

The method may also include importing protocol elements and questions 304. In an aspect, the system may import the protocol elements and associated questions from an external source. For example, the system may import the protocol elements and questions from company maintained data, industry standards, industry benchmarks, government regulations, company regulations, international standards, and/or a data repository. In addition, the system may also receive user inputs for the protocol elements and associated questions. For example, a user of the system may input the protocol elements and associated questions. In addition, the system may import a portion of the protocol elements and questions from an external source while receiving a portion of the protocol elements and questions from user input. The system may also identify a source for each element and/or question of the protocol, such as company maintained data, government regulations related to the questions, company requirements related to the questions, international standards, and industry benchmark information. Thus, when a question is presented during an assessment, for example, a user may easily identify the source of the question.

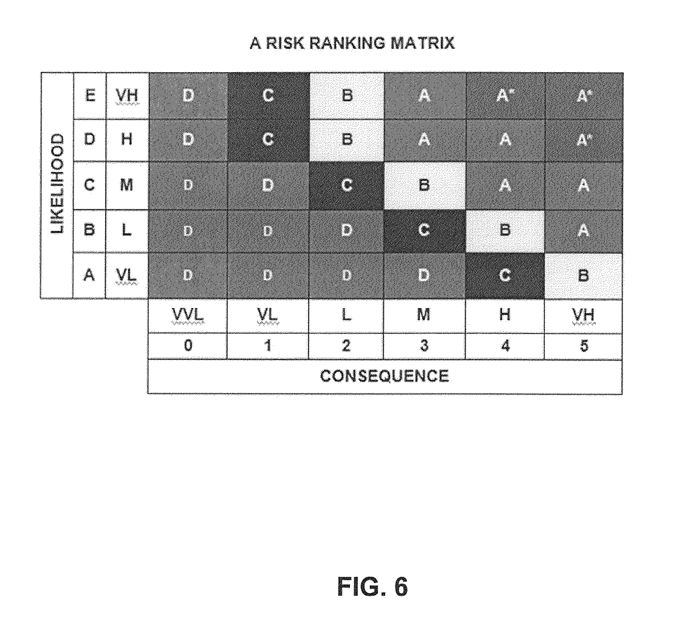

The method may include setting a scoring range for each protocol question 306. For example, the system may set a scoring range for each question. A score may be set as 1-4 or 1-100 or another user specified range. In an aspect, the system may use the scores for each question and answers to generate an overall score for the project that may be used by the system to measure, for example, the safety, security, and/or environmental programs of the project. In addition, the system may use the scores to aid in generating a risk matrix that may be used by the system to evaluate a severity and/or likelihood of a safety, security and/or environmental risk. A risk matrix may be any design of severity of a consequence (1-10 or alphanumeric levels) and likelihood (1-10 or alphanumeric levels) and then to specify a Risk value as the relationship of the severity of a consequence and Likelihood in as numeric or alphanumeric value. FIG. 6 is an example of a risk matrix in accordance with an aspect of the present invention.

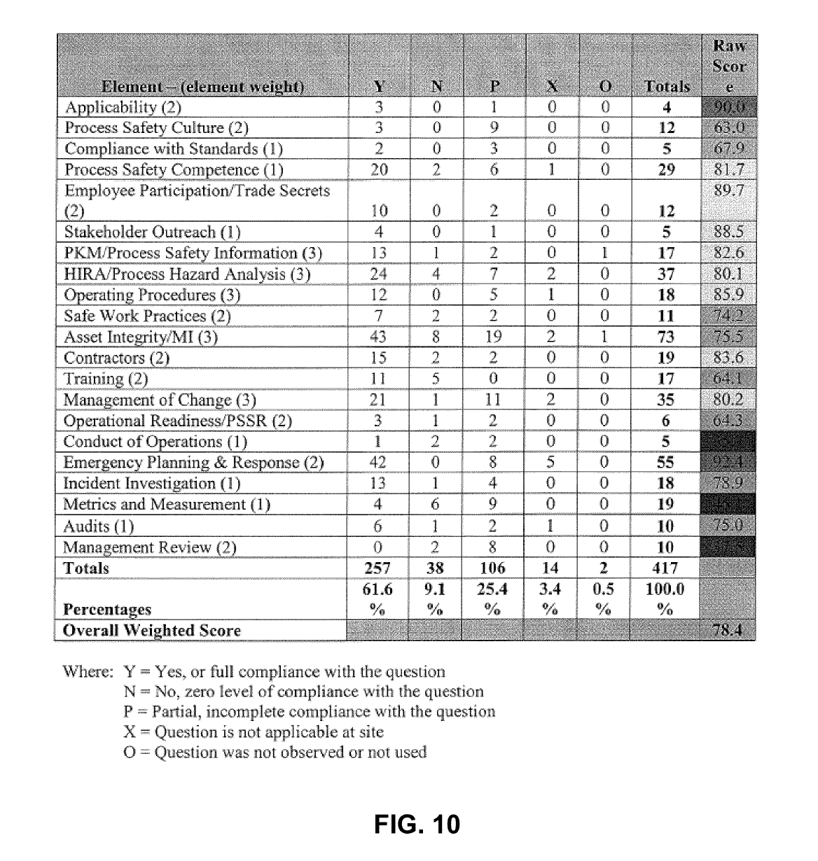

In addition, the method may include setting a weight for each protocol question 308. Weights may be a user specified optional expression of the importance of the question or elements of the management system being evaluated. With the user weights specified, for example, up to 7 digits in length, an algebraic formula may be defined by the system to emphasize the importance of questions and elements and the associated response in the assessment in defining the overall or element score. As an example, if there are 10 questions and two questions are critical then they may be given a higher weight (such as 4 on a scale of 4). Each weight can then be multiplied by a numeral associated with the response (such as Yes response=full points or 4 on a scale of 1-4) to obtain a weighted value of 16 (e.g., 4×4). In an aspect, the system may use the weights for each question and answers to measure, for example, the safety, security, and/or environmental programs of the project (e.g. FIG. 10). In addition, the system may use the weights to aid in generating a risk matrix that may be used by the system to evaluate a severity and/or likelihood of a safety, security and/or environmental risk.

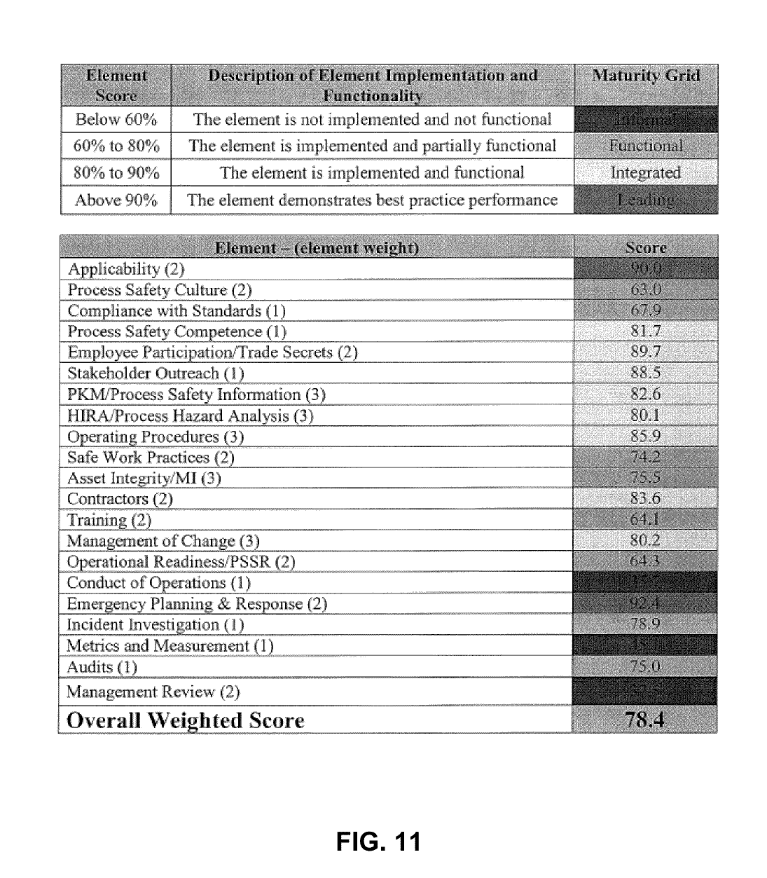

According to an aspect of the invention, when determining element scoring, each question is assigned a weight, Q_{W}, and a score, Q_{S} (e.g. FIG. 11). Each question is scored within a range (e.g. 1-4 or 1-100). Further, each question has a maximum score, Q_{SMAX}. The question weight may be assigned by the protocol creator, and the score may be assigned by the user(s) during the assessment. The element score may be calculated as follows:

$${E}_{S} = \frac{{\sum }_{i = 1}^{{Q}_{n}} {Q}_{W} * \frac{{Q}_{S}}{{Q}_{SMAX}}}{{\sum }_{i = 0}^{n} {E}_{W}} \qquad ( 1 )$$

In equation (1), E_{S} may be to the element score, 0-100%. Q_{W} may be equal to the question weight, which is assigned by the protocol creator. Q_{S} may be equal to the question score, which is assessed by the user and the range is defined in the protocol. Q_{SMAX} may be equal to the maximum possible score for each specific question, which is defined in the protocol. Qₙ may be equal to the total number of questions in the element.

According to an additional aspect, when determining the audit scoring, each element is assigned a weight in the protocol, E_{W} (e.g. FIG. 11). The total score for the assessment, Aₛ, is calculated as the weighted average of all the element scores. The audit score may be calculated as follows:

$${A}_{s} = \frac{{\sum }_{i = 1}^{{E}_{n}} {E}_{W} * {E}_{S}}{{\sum }_{i = 0}^{n} {E}_{W}} \qquad ( 2 )$$

In equation (2), Aₛ may be equal to the audit score, 0-100%. Eₛ may be equal to the element score, 0-100%. E_{W} may be equal to the element weight, which defined by the protocol. Eₙ may be equal to the total number elements.

In an aspect of the invention, the audit score, E_{S}, and element score Aₛ, may be used to generate a risk matrix that may be used by the system to evaluate a severity and/or likelihood of a safety, security and/or environmental risk.

In an optional aspect, the method may include setting a classification and a priority for the protocol questions and answers 310. For example, the system may receive user input selecting a classification and a priority (e.g., high, medium, low) for each question and answer. In an aspect, the system may use the classifications and priorities for each question and answer to measure the safety, security, and/or environmental programs of the project. In addition, the system may use the classifications and priorities to aid in generating a risk matrix that may be used by the system to evaluate a severity and/or likelihood of a safety, security and/or environmental risk.

The method may also include defining potential answers for each question 312. In an aspect, the system may define potential answers for each questions (e.g., yes/no, partial, not applicable, not observed, not used, text entry). For example, when a question must have either a yes or no answer, the system may not allow any other type of answer during the assessment. In addition, when a question relates to an industry standard and/or government regulation, the system may define the potential answers to the question based on the industry standard and/or government regulation.

Once a protocol has been created, the system may allow a user to update the protocol, delete the protocol, and/or share the protocol with other individuals. For example, the system may receive input from a user selecting a protocol to share with other individuals, contact information for the individuals (e.g., e-mail addresses, telephone numbers, social media information), a format for the protocol (e.g., document, spreadsheet, chart), and a format for sharing the protocol (e.g., via e-mail address, social media). The system may transmit the selected protocol to the various individuals.

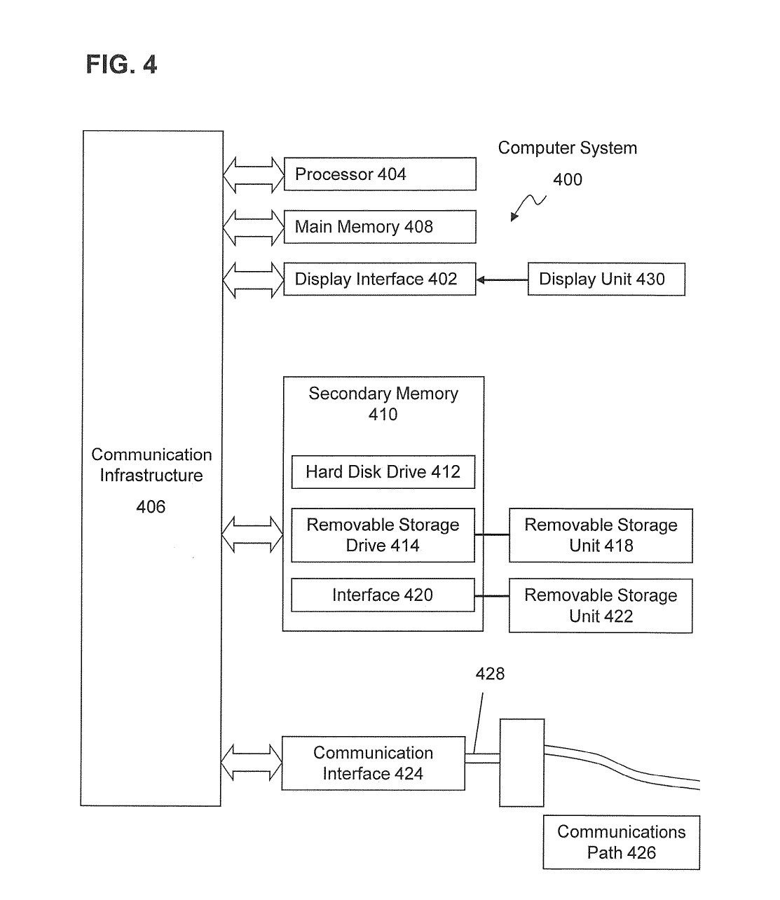

Aspects of the present invention may be implemented using hardware, software, or a combination thereof and may be implemented in one or more computer systems or other processing systems. In an aspect of the present invention, features are directed toward one or more computer systems capable of carrying out the functionality described herein. An example of such a computer system 400 is shown in FIG. 4.

Computer system 400 includes one or more processors, such as processor 404. The processor 404 is connected to a communication infrastructure 406 (e.g., a communications bus, cross-over bar, or network). Various software aspects are described in terms of this exemplary computer system. After reading this description, it will become apparent to a person skilled in the relevant art(s) how to implement aspects of the invention using other computer systems and/or architectures.

Computer system 400 can include a display interface 402 that forwards graphics, text, and other data from the communication infrastructure 406 (or from a frame buffer not shown) for display on a display unit 430. Computer system 400 also includes a main memory 408, preferably random access memory (RAM), and may also include a secondary memory 410. The secondary memory 410 may include, for example, a hard disk drive 412 and/or a removable storage drive 414, representing a floppy disk drive, a magnetic tape drive, an optical disk drive, a universal serial bus (USB) flash drive, etc. The removable storage drive 414 reads from and/or writes to a removable storage unit 418 in a well-known manner. Removable storage unit 418 represents a floppy disk, magnetic tape, optical disk, USB flash drive etc., which is read by and written to removable storage drive 414. As will be appreciated, the removable storage unit 418 includes a computer usable storage medium having stored therein computer software and/or data.

Alternative aspects of the present invention may include secondary memory 410 and may include other similar devices for allowing computer programs or other instructions to be loaded into computer system 400. Such devices may include, for example, a removable storage unit 422 and an interface 420. Examples of such may include a program cartridge and cartridge interface (such as that found in video game devices), a removable memory chip (such as an erasable programmable read only memory (EPROM), or programmable read only memory (PROM)) and associated socket, and other removable storage units 422 and interfaces 420, which allow software and data to be transferred from the removable storage unit 422 to computer system 400.

Computer system 400 may also include a communications interface 424. Communications interface 424 allows software and data to be transferred between computer system 400 and external devices. Examples of communications interface 424 may include a modem, a network interface (such as an Ethernet card), a communications port, a Personal Computer Memory Card International Association (PCMCIA) slot and card, etc. Software and data transferred via communications interface 424 are in the form of signals 428, which may be electronic, electromagnetic, optical or other signals capable of being received by communications interface 424. These signals 428 are provided to communications interface 424 via a communications path (e.g., channel) 426. This path 426 carries signals 428 and may be implemented using wire or cable, fiber optics, a telephone line, a cellular link, a radio frequency (RF) link and/or other communications channels. In this document, the terms “computer program medium” and “computer usable medium” are used to refer generally to media such as a removable storage drive 480, a hard disk installed in hard disk drive 470, and signals 428. These computer program products provide software to the computer system 400. The invention is directed to such computer program products.

Computer programs (also referred to as computer control logic) are stored in main memory 408 and/or secondary memory 410. Computer programs may also be received via communications interface 424. Such computer programs, when executed, enable the computer system 400 to perform the features in accordance with aspects of the present invention, as discussed herein. In particular, the computer programs, when executed, enable the processor 404 to perform the features in accordance with aspects of the present invention. Accordingly, such computer programs represent controllers of the computer system 400.

In an aspect of the present invention where the invention is implemented using software, the software may be stored in a computer program product and loaded into computer system 400 using removable storage drive 414, hard drive 412, or communications interface 420. The control logic (software), when executed by the processor 404, causes the processor 404 to perform the functions described herein. In another aspect of the present invention, the system is implemented primarily in hardware using, for example, hardware components, such as application specific integrated circuits (ASICs). Implementation of the hardware state machine so as to perform the functions described herein will be apparent to persons skilled in the relevant art(s).

In yet another aspect of the present invention, the invention is implemented using a combination of both hardware and software.

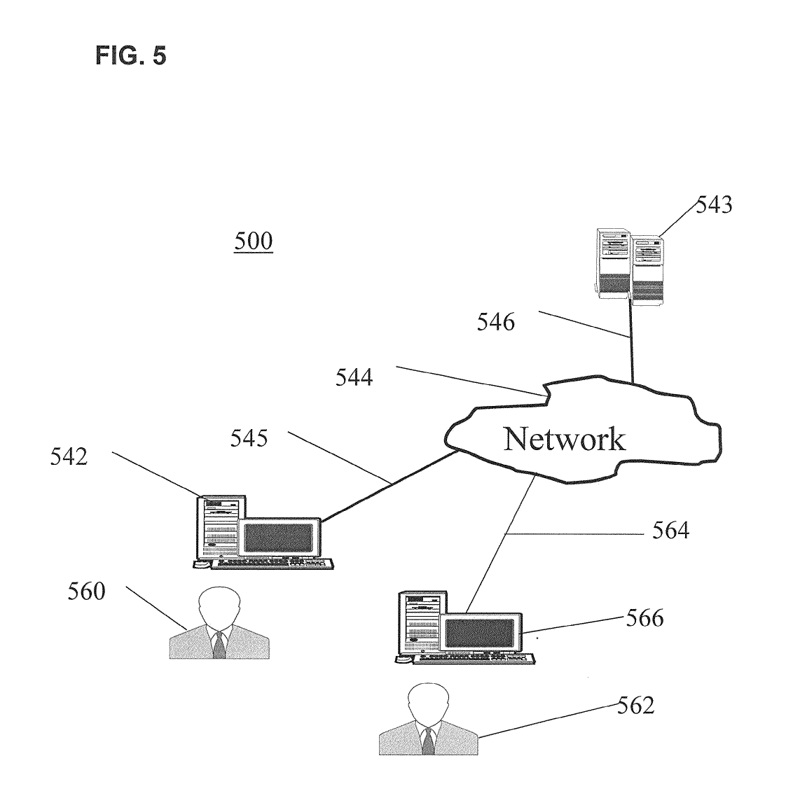

FIG. 5 shows a communication system 500 usable in accordance with aspects of the present invention. The communication system 500 includes one or more accessors 560, 562 (also referred to interchangeably herein as one or more “users”) and one or more terminals 542, 566. In one aspect of the present invention, data for use is, for example, input and/or accessed by accessors 560, 562 via terminals 542, 566, such as personal computers (PCs), minicomputers, mainframe computers, microcomputers, telephonic devices, or wireless devices, such as personal digital assistants (“PDAs”) or a hand-held wireless devices coupled to a server 543, such as a PC, minicomputer, mainframe computer, microcomputer, or other device having a processor and a repository for data and/or connection to a repository for data, via, for example, a network 544, such as the Internet or an intranet, and couplings 545, 546, 564. The couplings 545, 546, 564 include, for example, wired, wireless, or fiberoptic links. In another aspect of the present invention, the method and system of the present invention operate in a stand-alone environment, such as on a single terminal.

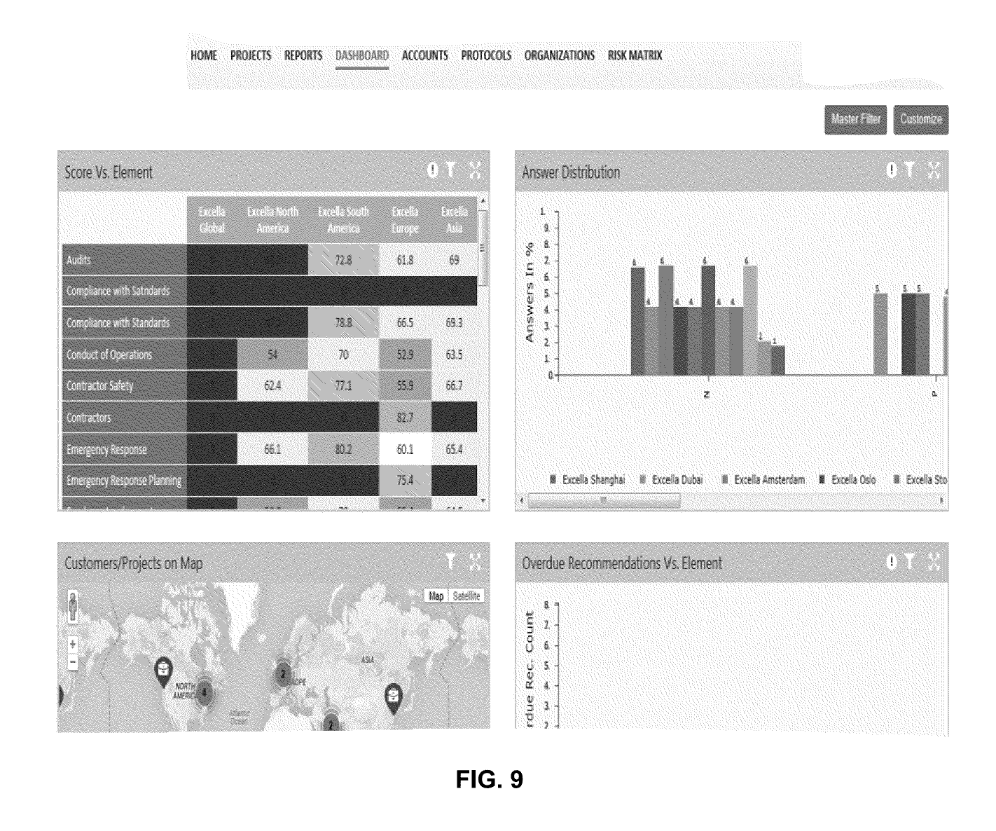

Referring now to FIG. 6, illustrated therein is an example of a risk ranking matrix. The risk ranking matrix may be generated and used in the assessment determination and presented on a dashboard. An example of a dashboard is shown in FIG. 9.

The risk ranking matrix may be generated at any point during an assessment to provide an associated evaluated risk ranking for a specified set of questions. For example, as shown in FIG. 6, the risk ranking matrix assigns a risk ranking at the intersection of a likelihood of an event and a severity of a consequence. The risk rank may be determined based upon inputs by the user(s) during an assessment of a company.

The risk ranking matrix may include one or more likelihood rankings/values and one or more severity of a consequence rankings/values. For example, as explained above, such rankings/values can be numbers, letters, or the like. Further, such rankings/values can range from a highest ranking/value to lowest ranking/value.

The method may include an input by a user in response to a specified set of questions during an assessment to generate at least a likelihood ranking/value and at least a severity of a consequence ranking/value. The risk matrix may determine a ranking of the risk relating to company standards, industry standards, best practices for an industry, international standards, and/or government regulations for the industry (e.g., OSHA).

The risk ranking matrix may provide a different risk ranking based upon different standards. For example, the risk ranking matrix may determine specific respective rankings/values for likelihood of an event and a severity of a consequence, based upon industry standards. In addition, a risk ranking matrix may determine different respective rankings/values for the likelihood of an event and a severity of a consequence, based upon OSHA standards. As explained above, the standards are configured based upon protocols.

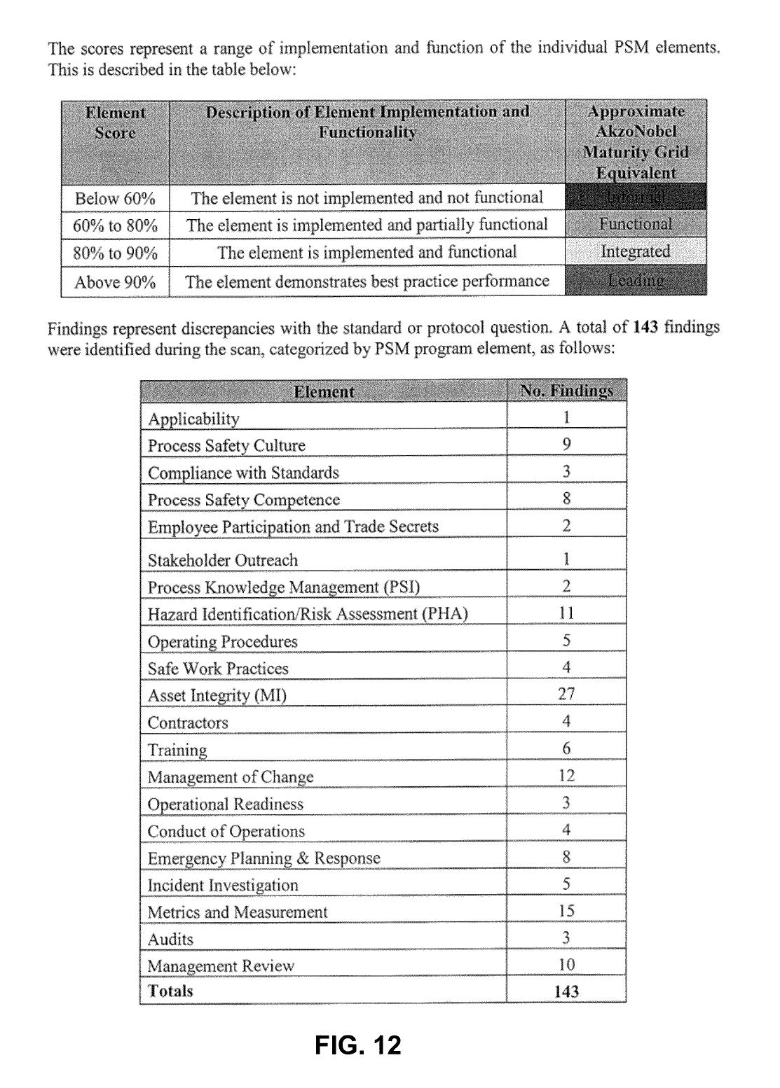

As shown in FIG. 6, according to an aspect of the invention, the risk ranking matrix may assign a risk rank ranging from letters “A*” to “D.” For example, “A*” may be the highest risk, while “D” may be the lowest. The risk ranking matrix may provide a qualitative measure that may be used to assess the need for, and prioritize the response to, action items and recommendations determined during an assessment (e.g. FIG. 12).

A risk ranking of “A*” may indicate an immediate response is required by the company of the assessment to reduce the risk to continue to operate. The response may consist of items such as: special administrative controls, additional information for operators, or installation of additional equipment/instrumentation (such as configuring of alarms) to compensate or mitigate the risk. These might be permanent measures or they might be only interim measures until more permanent protections can be put in place. If the company is not currently in operation, then these measures may be in place prior to startup.

A risk ranking of “A” may indicate a response is required by the company of the assessment to reduce the risk to continue to operate. The company may be required to complete permanent or temporary solutions, which would result in a risk ranking of B or lower, for example, within 12 months.

A risk ranking of “B” may indicate that a detailed analysis is required regarding the company's assessed risks. The company of the assessment may be required to complete permanent or temporary solutions to the assessed risks, based upon the conclusion from the additional analysis, for example, within 12 months.

A risk ranking of “C” may indicate that discretion is given to the company to complete permanent or temporary solutions to the assessed risks, within 24 months. Lastly, a risk ranking of “D” may indicate that continuous improvement of the company's assessed risks should be completed, for example, within 24 months.

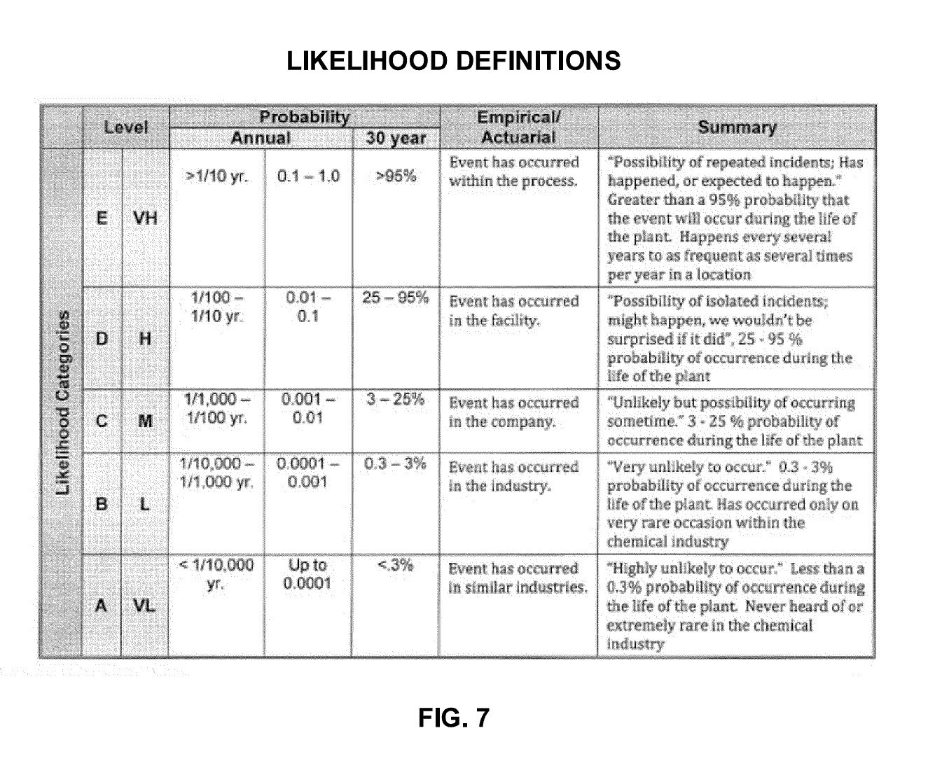

Referring now to FIG. 7, illustrated therein is an example of a table containing, definitions of the ranking/values for a likelihood of an event, interchangeably referred to herein as likelihood levels. The term likelihood of an event may be defined as the likelihood that the worst-case consequence will occur, given that all existing safeguards function as designed. The table shown in FIG. 7 is an example of how the likelihood level may be determined during an assessment in accordance with the risk ranking matrix. Likelihood may be assessed in terms of personal, plant, and industry experience and, as such, is subject to error or distortion.

In an aspect of the invention, the levels can range from letters E to A, or range from VH to VL. For example, E can be considered the highest likelihood of an occurrence, while A can be considered the lowest likelihood of an occurrence. Further, VH can be considered the highest likelihood of an occurrence while VL can be considered the lowest likelihood of an occurrence.

Further, in another aspect of the invention, the likelihood table may contain columns detailing the probability, the empirical/actuarial evidence and a summary of the likelihood level.

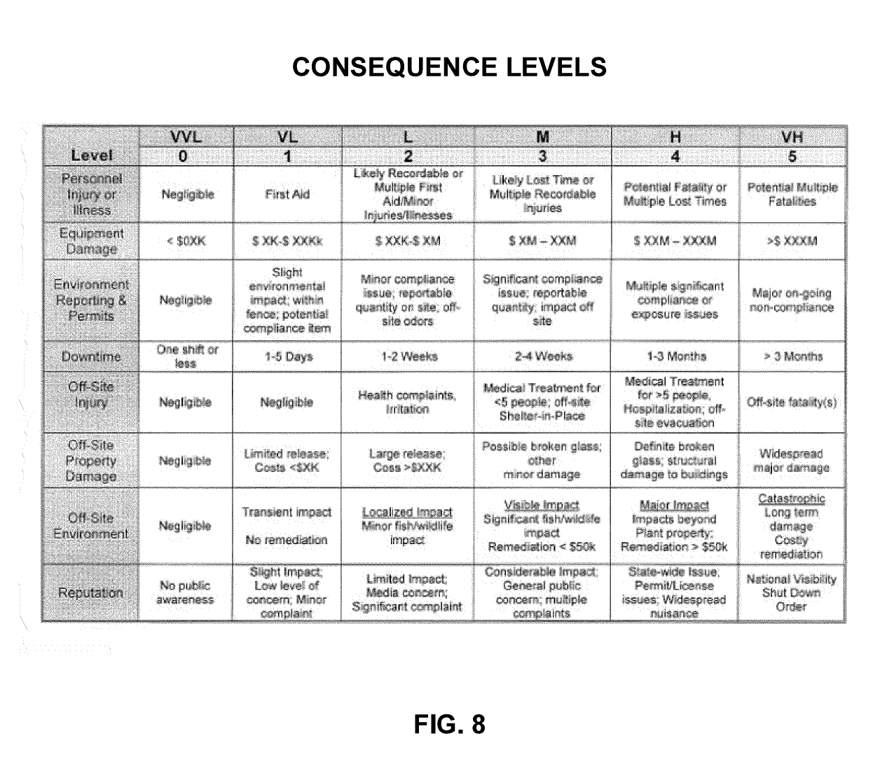

Referring now to FIG. 8, illustrated therein, is an example of a table containing, for example, definitions of the ranking/values of a severity of a consequence, called levels. A severity of a consequence may be defined as the outcome of a worst-case event. The table described in FIG. 8 is an example of how a severity of a consequence level may be determined during an assessment in accordance with the risk ranking matrix. The severity of a consequence level is assessed for personal, plants, equipment, environment, downtime, off-site damage, and the like, and as such, is subject to error or distortion.

In an aspect of the invention, the levels can range from letters VH to VVL, or range from 5 to 1. For example, VH can be considered the highest severity of a consequence level, while VVL can be considered the lowest severity of a consequence. Further, 5 can be considered the highest severity of a consequence level, while 0 can be considered the lowest severity of a consequence level.

Further, in another aspect of the invention, the consequence table may contain columns and rows detailing the costs, lost time, lost profits, affect of reputation, etc., associated with the respective consequences.

Both the likelihood levels and the severity of consequence levels are subject to error or distortion by the user(s). For example, to try and avoid gross inaccuracies, a user may make use of a multi-functional team to assess a consequence level and likelihood level and strive for a consensus.

While aspects of the present invention have been described in connection with examples thereof, it will be understood by those skilled in the art that variations and modifications of the aspects of the present invention described above may be made without departing from the scope hereof. Other aspects will be apparent to those skilled in the art from a consideration of the specification or from a practice in accordance with aspects of the invention disclosed herein.

1. A method for managing assessment, the method executed on an apparatus having a processing device, the method comprising:
creating a project for an assessment associated with a company and a particular site for a selected issue or issues;
selecting a protocol for the project, wherein the protocol includes one or more elements with associated questions;
receiving assessment information in response to the questions; and
generating, via the processing device, a report based on the assessment information.

2. The method of claim 1, further comprising:
setting a score and a weight for each of the questions;
calculating a risk for the project using the score, the weight, and the assessment information;
generating a risk matrix report illustrating the risk; and
presenting the risk matrix and assessment information in a dashboard showing user specified graphs and charts illustrating cumulative near real time results across all assessments for all sites owned by the company or illustrating comparisons to requirements or industry benchmark data.

3. The method of claim 1, wherein the protocol is related to one or more of a government regulation, an industry standard, and a company regulation.

4. The method of claim 1, further comprising:
assigning one or more user accounts to the project, wherein the user accounts have associated access rights to the project; and
assigning one or more elements and questions to the user accounts.

5. The method of claim 2, wherein the risk matrix determines a risk based upon a likelihood of an occurrence or a severity of a consequence.

6. The method of claim 5, wherein the determined risk indicates procedures the company or the particular site to addresses.

7. An apparatus for managing assessment, comprising:
a processing device configured to:
create a project for an assessment associated with a company and a particular site for a selected issue or issues;
select a protocol for the project, wherein the protocol includes one or more elements with associated questions;
receive assessment information in response to the questions; and
generate a report based on the assessment information.

8. The apparatus of claim 7, wherein the processing device is further configured to:
set a score and a weight for each of the questions;
calculate a risk for the project using the score, the weight, and the assessment information;
generate a risk matrix report illustrating the risk; and
present the risk matrix and assessment information in a dashboard showing user specified graphs and charts illustrating cumulative near real time results across all assessments for all sites owned by the company or illustrating comparisons to requirements or industry benchmark data.

9. The apparatus of claim 7, wherein the protocol is related to one or more of a government regulation, an industry standard, and a company regulation.

10. The apparatus of claim 7, wherein the processing device is further configured to:
assign one or more user accounts to the project, wherein the user accounts have associated access rights to the project; and
assign one or more elements and questions to the user accounts.

11. The apparatus of claim 8, wherein the risk matrix determines a risk based upon a likelihood of an occurrence or a severity of a consequence.

12. The apparatus of claim 11, wherein the determined risk indicates procedures the company or the particular site to addresses.

13. A non-transitory computer-readable storage medium having stored therein an assessment program, the assessment program comprising the method of:
creating a project for an assessment associated with a company and a particular site for a selected issue or issues;
selecting a protocol for the project, wherein the protocol includes one or more elements with associated questions;
receiving assessment information in response to the questions; and
generating, via the processing device, a report based on the assessment information.
